(19) United States
(12) Patent Application Publication
(10) Pub. No.: US 2024/0375445 A1
(43) Pub. Date: Nov. 14, 2024

(54) TIRE WITH IMPROVED TRANSVERSE GRIP PERFORMANCE ON SNOW-COVERED SURFACES

(71) Applicant: COMPAGNIE GENERALE DES ETABLISSEMENTS MICHELIN, Clermont-Ferrand (FR)

(72) Inventor: VINCENT TOURNEUX, Clermont-Ferrand (FR)

(21) Appl. No.: 18/691,271

(22) PCT Filed: Sep. 5, 2022
(86) PCT No.: PCT/FR2022/051670

§ 371 Date: Mar. 12, 2024

(30) Foreign Application Priority Data
Sep. 17, 2021 (FR) 2109770

(51) Int. Cl. B60C 11/03; B60C 11/12

(52) U.S. Cl. CPC B60C 11/0318; B60C 11/0302; B60C 11/1236

(57) ABSTRACT

The invention relates to a tyre with improved performance in terms of transverse grip on snow-covered surfaces without a resulting impairment in performance in terms of grip on wet and dry surfaces. The tread is obtained by repeating the tread pattern elements (MA, MB) at pitches (PA, PB) over a complete circuit of the tyre, with PA<PB. Each first lateral portion (ZB) of said tread pattern elements contains at least one longitudinal sipe (50) of which the path on the tread surface (15) is a mean plane (53) that makes an angle Beta with the circumferential direction, which angle is comprised within the range [0°, 20°]. This same mean plane (53) also makes an angle Alpha with the direction (Npsup) normal to the tread surface (15), which angle is comprised within the range [3°; 55°], and the sum of the projected lengths of the longitudinal sipes (50) in the circumferential direction onto all of the first lateral portions (ZB) is comprised between 0.5 times and 5 times the circumference of the tyre measured in the equatorial plane.

### TECHNICAL FIELD

The present invention relates to a tyre for a motor vehicle, and more particularly to a snow tyre intended to be fitted to a passenger vehicle or to a van.

What is meant by snow tyre is a tyre that meets the international regulatory requirements of UNECE/R117 (regulation 117 of the Economic Commission for Europe of the United Nations). Such a tyre passes the test of ASTM 1805 for grip on snow-covered surfaces, and on at least one of its sidewalls bears the distinctive Three-Peak Mountain Snowflake (3PMSF) logo.

The invention also relates to multipurpose tyres that can be used for all four seasons. In general, these tyres bear an “M+S” (Mud and Snow) marking on at least one of their sidewalls. Commercially, they are referred to as “all seasons” tyres.

What is meant by grip is both the grip performance of the tyre in the direction transverse to the direction of travel of the vehicle, such as road holding under cornering, and the grip performance of the tyre in the direction longitudinal to the direction of travel of the vehicle, namely the possibility of transmitting a braking or driving force to the ground.

Transverse grip on snow-covered surfaces may be encountered for example in tight bends for motorway exits or else on winding mountain roads which are covered in snow in the winter. The invention seeks to improve transverse grip on snow-covered surfaces without a resulting impairment to longitudinal grip.

### DEFINITIONS

In the following text, the circumferential, axial and radial directions refer to a direction tangential to any circle centred on the axis of rotation of the tyre, to a direction parallel to the axis of rotation of the tyre, and to a direction perpendicular to the axis of rotation of the tyre, respectively.

By convention, in a frame of reference (O, XX′, YY′, ZZ′), the centre O of which coincides with the centre of the tyre, the circumferential direction XX′, axial direction YY′ and radial direction ZZ′ refer to a direction tangential to the tread surface of the tyre in the direction of rotation, to a direction parallel to the axis of rotation of the tyre, and to a direction orthogonal to the axis of rotation of the tyre, respectively.

Radially inner and radially outer mean closer to and further away from the axis of rotation of the tyre, respectively.

Axially inner and axially outer mean closer to and further away from the equatorial plane of the tyre, respectively, the equatorial plane of the tyre being the plane that passes through the middle of the tread of the tyre and is perpendicular to the axis of rotation of the tyre.

A tyre comprises a crown intended to come into contact with the ground via a tread, the two axial ends of which are connected via two sidewalls to two beads that provide the mechanical connection between the tyre and the rim on which it is intended to be mounted.

The “tread surface” of a tread means the surface that groups together all the points of the tyre that will come into contact with the ground under normal running conditions. These points that will come into contact with the ground belong to the contact faces of the blocks. For a tyre, the “normal running conditions” are the use conditions defined by the ETRTO (European Tyre and Rim Technical Organisation) standard. These use conditions specify the reference inflation pressure corresponding to the load-bearing capacity of the tyre as indicated by its load index and its speed rating. These use conditions can also be referred to as “nominal conditions” or “working conditions”.

The total width of the tread is the axial distance between the axial ends of the tread surface, these being distributed over each side of the equatorial plane of the tyre. From a practical standpoint, an axial end of the tread surface does not necessarily correspond to a point that is clearly defined. In the knowledge that the tread is delimited externally, on the one hand, by the tread surface and, on the other hand, by two surfaces where it meets two sidewalls that connect said tread to two beads intended to provide the connection to a mounting rim, an axial end can therefore be defined mathematically as being the orthogonal projection, onto the tread, of a theoretical point of intersection between the tangent to the tread surface in the axial end zone of the tread surface and the tangent to the connecting surface in the radially outer end zone of the connecting surface. The total width of the tread corresponds substantially to the axial width of the contact surface when the tyre is subjected to the recommended load and pressure conditions.

The portion of a tyre that is comprised between the radially outer end of the sidewall and the axially outer end of the tread is referred to as the shoulder. The leading shoulder is the one in which the transverse loadings in a given corner are directed towards the centre of the contact patch. By definition, still for the same corner, the trailing shoulder is the one that is axially opposed.

The tread is generally made up of the repetition of raised volumetric elements known as tread pattern elements in the circumferential direction, which are separated from one another by cuts. A tread pattern element groups together a collection of raised elements, from a first axial end of the tread to a second axial end.

The pitch of a tread pattern element is the distance, measured on a circumference of the tyre, between a point on this tread pattern element and the translated image of this point on the immediately next tread pattern element.

A tread with a single tread pattern element is known as a mono-pitch tread. However, in general, the tread of a tyre for a passenger vehicle is made up of a circumferential repeat of two or three tread pattern elements with a pitch length of between 20 mm and 40 mm. In general, two consecutive tread pattern elements are homothetic.

In order to increase the grip potential of a tread of a tyre running on a road surface covered with snow or with water, it is known practice to provide this tread with a pattern made up of a plurality of cuts produced to a greater or lesser depth in each tread pattern element, said cuts opening onto the tread surface in contact with the road.

A cut means any void created in the tread, whether by removing material once the tread has been vulcanized or by moulding in a mould for moulding said tread and comprising moulding elements that project from the moulding surface of said mould, each moulding element having a geometry identical to the geometry for the desired cut. As a general rule, a cut made in a tread is delimited by at least two walls of rubber that face one another, said walls being separated by a mean distance representing the width of the cut, the intersection of said walls with the tread surface forming edge corners. A distinction is made between several types of cut, for example:
grooves or channels which are characterized by a width greater than approximately 10% of the thickness of the tread;
sipes, the width of which is relatively small compared with the thickness of the tread; under certain loading conditions, these sipes may at least partially close in the contact patch in which the tyre is in contact with the road; the opposing walls come into contact with one another at least over a greater or lesser proportion of the surface area of said walls (the edge corners formed by a sipe on the tread surface are in contact with one another thus closing the sipe). In general, the distance between the walls of material that delimit a sipe is less than or equal to 2 mm and the depth is greater than or equal to 1 mm.

Some cuts may open into at least one other cut. The path of a cut along the tread surface of a tread follows a mean geometric profile which is determined as being the geometric profile situated at a mean distance from the edge corners formed by the walls of said cut on the tread surface. The mean axis of the path of a cut on the tread surface corresponds to the straight-line of least squares of the distances of the points of the mean profile of the path of said cut.

By making a plurality of cuts that open onto the tread surface, a plurality of edge corners of rubber that bite into the layer of water possibly present on the road is created, thereby keeping the tyre in contact with the ground and creating cavities that may form ducts intended to collect and remove the water present in the contact patch in which the tyre is in contact with the road provided that these cavities are arranged in such a way as to emerge somewhere outside of the contact patch.

### PRIOR ART

Examples of multi-siped tread patterns can be found in documents: JP H07266809A, JP 2006232218A, US 2003/205305A1, JP H0971108A, WO 2019/226168A1, JP H0495510A, U.S. Pat. No. 2,294,626A, EP 0256247A2, DE 4337572A1, and FR 1583770A.

One example of such a tread pattern can be found in patent U.S. Pat. No. 1,452,099, which describes a tread provided with a plurality of uniformly spaced transversely oriented sipes.

However, increasing the number of cuts rapidly leads to a significant reduction in the stiffness of the tread, and this has an unfavourable impact on the performance of the tyre and even on the grip performance. What is meant by the stiffness of the tread is the stiffness of the tread under the combined actions of compression loading and shear loading in the region affected by contact with the road. At the same time, the presence of numerous cuts forming water discharge channels leads to a level of tyre noise, when running on a dry surface, which is nowadays considered to be unacceptably high, and which it is desirous to reduce as much as possible, particularly on vehicles of fairly recent design. This tyre noise is amplified by the cyclic movements of opening and closing of the cuts as well as the rubbing-together of the walls of said cuts when these cuts are closed.

Patent FR 1028978 proposes a solution to this problem which consists in providing the tread with a plurality of shallow-depth circumferential sipes on the tread surface of the new tread so as to increase the flexibility of said tread in the vicinity of the tread surface alone.

However, since the tyre is intended, once it has been mounted on a vehicle, to provide good performance throughout the life of said tyre (namely until its tread has worn down as far as at least the legal limit), it is necessary to provide a tread of which the tread pattern provides lasting grip performance on wet and snow-covered surfaces.

It is an object of the present invention to create a tyre having a tread which combines both a very high level of transverse grip on wet and/or snow-covered surfaces, without a resulting impairment to dry grip and which creates road noise that meets the regulations when the tyre is new and throughout the life of said tyre.

### SUMMARY OF THE INVENTION

According to the invention, what is proposed is a tyre comprising a tread which is intended to come into contact with the ground via a tread surface:
said tread comprising raised elements that are organized into at least two tread pattern elements (MA, MB) which are separated from one another at least in part by cuts and extend radially towards the outside from a bottom surface as far as the tread surface over a maximum radial height Hsre at least equal to 6 mm;
the path of a cut along the tread surface defining a mean geometric profile which is situated at a mean distance from the edge corners formed by the walls of said cut;
in a meridian section of the tyre, a point M being defined at the intersection of the mean geometric profile and of the tread surface; at this point M, Npsup is the external normal to the tread surface;
there being a pitch PA (or respectively PB) associated with the tread pattern element MA (or respectively MB), the pitch of a tread pattern element being the distance, measured on a circumference of the tyre, between a point on this tread pattern element and the translated image of this point on the immediately next tread pattern element;
the complete tread being obtained by repeating the tread pattern elements (MA, MB) at the pitches (PA, PB) over a complete circuit of the tyre, with PA<PB;
each tread pattern element (MA, MB) comprising a first lateral portion (ZB) extending from one axial end of the edge of the tread over an axial width at most equal to 25% of the axial width W of the tread;
a longitudinal sipe being a cut in at least a lateral portion (ZB) of a tread pattern element (MA, MB) in which the distance between the walls of material that delimit said sipe is less than or equal to 2 mm and the depth of which is greater than or equal to 1 mm;
each first lateral portion (ZB) contains at least one longitudinal sipe of which the path on the tread surface is a mean plane that makes an angle Beta with the circumferential direction (XX′), which angle, in terms of absolute value, is comprised within the range [0°, 20°];
said mean plane of said at least one longitudinal sipe makes an angle Alpha with the external normal (Npsup), which angle is comprised within the range [3°; 55°], said angle Alpha being oriented from the normal direction Npsup towards the mean plane;
the sum of the projected lengths of said at least one longitudinal sipe in the circumferential direction (XX′) onto all of the first lateral portions (ZB) is comprised between 0.5 times and 5 times the circumference of the tyre measured in the equatorial plane.

The principle of the invention is for the longitudinal sipes to be sited at the lateral ends of the tread pattern elements in order to improve the grip on wet and snow-covered surfaces. The inventors have observed that the invention yields better results in comparison with the usual designs of tread when the angle Beta of the mean plane of the longitudinal sipes with respect to the circumferential direction is comprised, in terms of absolute value, between 0° and 20°. Likewise, when the mean plane of said longitudinal sipes makes an angle Alpha with the direction normal to the outside of the tread surface that varies from 0° to 25°, the effectiveness of said longitudinal sipes at drying the ground or else at removing the snow in order to encourage grip, is improved.

In order to be truly effective, the longitudinal sipes need to be sufficient in number within the contact patch. For example, for a tyre size of 245/35 R 20, the sum of the length of the longitudinal sipes of the lateral portions ZB over a complete circuit of the tyre, projected in the circumferential direction, needs to be comprised between [1054; 10540] mm. For another size of tyre, 305/30 R 20, said sum needs to be between [1101; 11011] mm. The number of sipes expressed as a function of the circumference is therefore specified in terms of the tyre size.

According to the inventors, such longitudinal sipes oriented substantially parallel to the direction of travel of the vehicle improve the compromise between transverse grip on snow-covered surfaces and on dry surfaces. Specifically, in snow use, where there is little transfer of transverse load from one axle of the vehicle to another, the contact patch resulting from the deformation of the tread under the action of the carried load does not adopt the trapezoidal shape usually observed on dry and wet surfaces with usual designs. The contact patch therefore deforms far more uniformly and contains most of the longitudinal sipes.

Furthermore, the tyre has a tendency to bite into the snow, and this encourages contact between the trailing shoulder and the snow.

The longitudinal sipes in the trailing shoulder in a corner operate as if brushed back against their natural direction, thus binding and promoting transverse grip on snow. For that to happen, the orientation of the angle made by the mean plane of the longitudinal sipe with respect to the normal direction Npsup is an essential factor in the correct operation of the invention, as it generates an acute-angled leading edge corner on the trailing shoulder. The angle Alpha is oriented from the external normal direction Npsup towards the mean plane in order for the invention to work fully.

In use on dry ground, under transverse loading, the tyre is at a sideslip angle and experiences a transfer of load. This has the effect of deforming the contact patch into a trapezoidal shape, with the leading shoulder of the tread being more heavily loaded than the trailing shoulder. Thanks to the angle Alpha of the mean plane of the longitudinal sipe with respect to the direction Npsup, notably on the leading shoulder, the longitudinal sipes deform by closing, thereby stiffening the shoulder of the tyre and therefore preserving same.

The angle made by the mean plane of the longitudinal sipe with respect to the normal direction Npsup is an essential factor in the correct operation of the invention, as it generates an obtuse-angled leading edge corner on the leading shoulder.

The invention also proposes a compromise between the performance aspect of tyre noise and the performance aspect of grip on snow-covered or wet surfaces, where the longitudinal sipes of the lateral portions of the edges of the tread are defined in a manner correlated with the elements of the tread pattern.

The tread pattern is designed on the basis of a basic pattern element MA which comprises raised elements extending from a first axial end of the tread to a second axial end. A pitch PA is associated with this tread pattern element. A second tread pattern element MB with an associated pitch PB can be deduced from MA by homothety. Starting out from the positioning of a first tread pattern element on the crown of the tyre, and travelling a circumferential distance corresponding to the associated pitch, a homothetic second tread pattern element is positioned after the first tread pattern element. By running this algorithm over a complete circuit of the tyre, a tread is obtained that is made up of a succession of homothetic tread pattern elements. Two tread pattern elements may differ in terms of their circumferential width, their sipe density and/or their associated pitch.

According to the inventors, there are two major types of feature which are caused by the impact of the tread pattern elements on the roadway: whining and beating. These are features of which the acoustic power is much greater than the mean power of the spectrum and to which the human ear is particularly sensitive.

The timing of the impacts of the tread pattern on the ground on entering the contact patch is given its pattern by the order of succession of the elements. If the elements are all the same size, they follow one another with a perfectly regular rhythm. One single frequency will then be brought about, and this will produce a “whine”-like sound. Having several sizes of element makes it possible to scramble the sound signal emitted by the tread pattern of the tyre, that is to say to reduce the features, so as to tend towards white noise.

The succession of the elements of the tread is designed so as to attenuate whining and beating. Thus, designing the tread pattern on the basis of homothetic tread pattern elements makes it possible to control the level of noise emitted by the tyre during running.

All of the features of the invention work together towards obtaining the tyre of the invention which is characterized in that it achieves a compromise in terms of performance in transverse grip on snow by virtue of the longitudinal sipes in suitable quantity and orientation, while at the same time exhibiting a level of tyre noise that conforms to regulatory requirements.

Other features associated with various embodiments of the invention contribute towards further improving the tyre grip performance. Usually, these features relate to the geometry of the longitudinal sipes, the orientation thereof or else the density thereof within each tread pattern element.

Advantageously, the angle Alpha is comprised within the range [5°; 55°], and preferably within the range [7°; 55°].

Advantageously also, the angle Beta is comprised within the range [5°; 15°], and preferably within the range [7°; 10°].

The orientation of the longitudinal sipes, which orientation is defined by the angles (Alpha and Beta) of the mean plane thereof, is a parameter that influences the compromise in desired performance. The invention works when the angle Alpha varies from 5° to 55°, but yields optimal results in a narrower range from 7° to 55°. Likewise, the angle Beta of the mean plane of the longitudinal sipes with respect to the circumferential direction has a significant impact on the performance compromise when it is comprised within the range [5°; 15°]. The angle Beta is to be considered in terms of absolute value whereas the angle Alpha is oriented from the normal direction Npsup towards the mean plane of the longitudinal sipe.

Advantageously, each lateral portion ZB contains at least two longitudinal sipes, preferably three longitudinal sipes, and more preferably still, four longitudinal sipes.

The presence of longitudinal sipes is truly effective only if the sipe density and distribution over the tread pattern elements are high enough.

According to one embodiment, the angles Beta of the longitudinal sipes with respect to the circumferential direction vary such that they increase from the edges towards the centre of the tread, and the axial distance between two consecutive longitudinal sipes of a lateral portion ZB is comprised between [3; 17] mm, preferably between [4; 12] mm, and more preferably still, between [5; 8] mm, the axial distance between two consecutive longitudinal sipes being the distance between the two closest ends.

Advantageously, a contact patch being defined by those points of the tyre that are in contact with the ground when the tyre is compressed by a load at a nominal pressure, the load and pressure being as specified according to the ETRTO (European Tyre and Rim Technical Organisation), the longitudinal sipe which is axially outermost and in contact with the ground is situated at most 10 mm away from a first circumferential edge of the contact patch, and more preferably between 3 mm and 5 mm away.

Advantageously also, the longitudinal sipe which is axially innermost and in contact with the ground is situated at most 60 mm away, and more preferably at most 50 mm away, from a first circumferential edge of the contact patch.

According to another embodiment of the invention, the depth h of a longitudinal sipe is

between 20% and 80%, and preferably between 30% and 50%, of the maximum radial height of the tread pattern Hsre.

Advantageously, with the width of a sipe being the axial distance between the two walls of the sipe, said width is comprised between 0.3 mm and 2 mm, and preferably between 0.4 mm and 1 mm.

The inventors have identified features associated with the cuts in the tread, with its volumetric and area void ratios.

As a preference, with the overall volumetric void ratio TEV corresponding to the ratio of the void volume VE to the total volume VT of the tread, such that TEV=VE/VT, the overall volumetric void ratio TEV of the tread is comprised between [20%, 40%], and preferably between [25%, 35%].

For the performance aspect of grip, the void ratio has a rack effect for promoting the grip of the tyre in the snow. This rack effect is amplified with a directional tread pattern comprising cuts. According to the inventors, an overall void ratio TEV comprised between [20%, 40%] and preferably between [25%, 35%] is necessary in order to have a performance of grip on snow that is in accordance with expectation.

Furthermore, the volumetric void ratio also defines the volume of elastomeric material of which the tread is made that is intended to be worn away. The void ratio is therefore a sensitive parameter for determining the compromise of the performance aspects of the tyre such as wear, grip and noise.

Advantageously, with the tread forming a contact patch AC in which the tyre is in contact with the ground when said tyre is running, and with part of the tread pattern elements also forming a contact surface SC in said contact patch AC thereby determining an area void ratio TES of the tread, where

$$TES = \frac{{A}_{C} - {S}_{C}}{{A}_{C}} ,$$

TES is comprised within the range [0.35; 0.6], preferably TES is at least equal to 0.38, and more preferably still, TES is at least equal to 0.4.

The inventors have identified other features associated with the pitch of the tread pattern elements in order to manage the compromise between the grip of the tyre and the tyre noise.

As a preference, the ratio between the pitch PA of the first tread pattern element MA divided by the pitch PB of the second tread pattern element MB, PA/PB, is at least equal to 0.60 and at most equal to 0.90.

As a further preference, with the tread comprising at least a third tread pattern element MC with an associated pitch PC, where PB is smaller than PC, the ratio of the pitches PB/PC is greater than or equal to the ratio of the pitches PA/PB.

The ratio PA/PB of the shortest pitch PA of the first tread pattern element divided by the longest pitch PB of the second tread pattern element is comprised within the range [0.6; 0.9]. The smallest pitch and the longest pitch are in a ratio ideally equal to 0.85, or at least included within the range [0.6; 0.9].

When the pitch ratio is less than 0.6, the difference between the two pitches becomes too large and causes an excessive discontinuity of the arrangement of the tread pattern elements over a complete circuit of the tyre.

Conversely, for a pitch ratio above 0.9, the distance between tread pattern elements becomes too small, and the tread pattern of the tread gets close to a mono-pitch solution, which is not satisfactory as regards the level of noise generated.

In the design of a tread for a snow tyre, the choice of the tread material is an essential step. The chemical composition of the material of the tread is formulated in such a way that it remains flexible at low temperature, thereby increasing the grip on slippery (wet, snowy and icy) surfaces. What is meant by low temperature is a temperature of below 7° C.

Advantageously, the composition of the rubbery material of the tread has a glass transition temperature Tg comprised between −40° C. and −10° C. and preferably between −35° C. and −15° C. and a complex dynamic shear modulus G* measured at 60° C. comprised between 0.5 MPa and 2 MPa, and preferably between 0.7 MPa and 1.5 MPa.

The grip of the tyre on the ground obeys at least two physical phenomena: adhesion and indentation. For example, for wet ground, the tread pattern of the tread removes water from the ground to provide grip by means of the dry tread surface sticking to the ground. In parallel, the flexibility of the material of the tread makes it possible to conform to the irregularities of the ground by indentation in order for the tyre to hold to the road. The material needs to remain flexible and effective at temperatures below 7° C. According to the inventors, an elastomeric material having a glass transition temperature Tg comprised between −40° C. and −10° C. and preferably between −35° C. and −15° C. and a complex dynamic shear modulus G* measured at 60° C. comprised between 0.5 MPa and 2 MPa, and preferably between 0.7 MPa and 1.5 MPa, gives the tread the appropriate physical properties to achieve the desired performance compromises.

### BRIEF DESCRIPTION OF THE DRAWINGS

The present invention will be understood better from reading the detailed description of embodiments considered by way of entirely non-limiting examples and illustrated by the appended drawings, in which:

FIGS. 1-A, 1-B, 1-C depict two tread pattern elements (MA, MB) having longitudinal sipes.

FIG. 2 shows a developed view of the tread in the circumferential direction (X) according to one embodiment of the invention, with two tread pattern elements MA and MB. The tread pattern elements differ in terms of their geometry (widths, cuts, pitches, etc.). The element MA is depicted with small dots on a pale background, and the element MB with a grey background.

FIGS. 3-A, 3-B, 3-C, and 3-D are views in a meridian plane, depicting the longitudinal sipes. It is also possible to see the direction normal to the surface of the tread for defining the angle Alpha between the mean plane of a longitudinal sipe and said normal direction.

### DETAILED DESCRIPTION OF THE INVENTION

The invention was studied more particularly in the case of a passenger vehicle tyre of standardized designation, according to the ETRTO (European Tyre and Rim Technical Organisation), 245/35 R20 XL 95V. For this size, a version of the tyre according to the invention with a tread comprising two tread pattern elements MA and MB, with respective variable pitches PA and PB, was produced.

In the various figures, identical or similar elements bear the same references. Given the symmetry of the tread, in order for the figures to be readable, the elements are referenced once sometimes on the left side 24G and sometimes on the right side 24D.

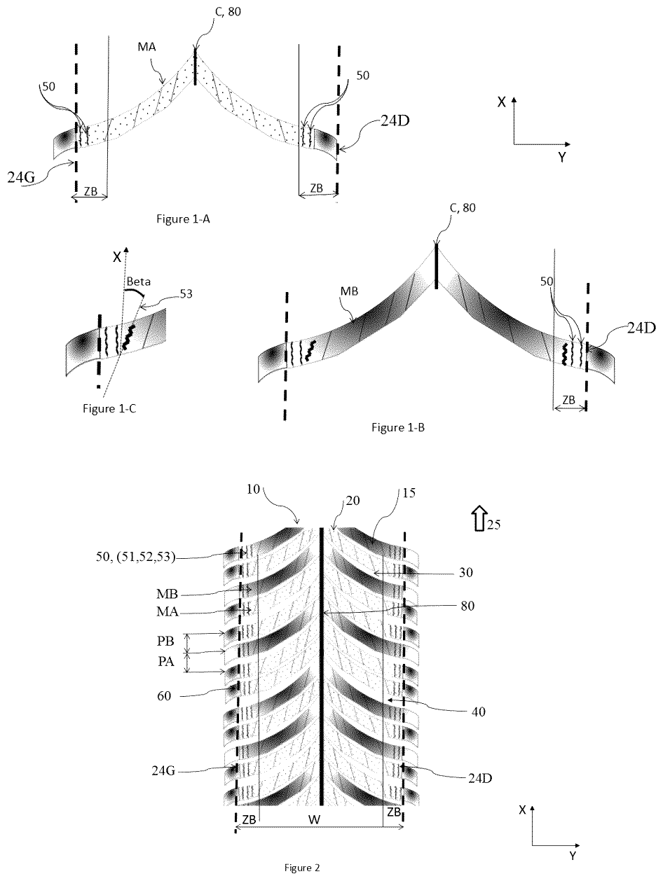

FIG. 1-A depicts a first element MA of the tread pattern of the tread. The longitudinal sipes 50 are sited on the lateral portions ZB situated at the axial ends (24D, 24G) of the tread pattern element MA, on each side of the equatorial plane C. For the tyre size being studied, the pitch PA is equal to 21.9 mm.

FIG. 1-B depicts a second element MB of the tread pattern of the tread. MB differs from MA in that its width, measured in the circumferential direction, is greater than that of MA. The number of cuts may also differ between the two elements. For the tyre size being studied, the pitch PB is equal to 29.37 mm.

In the FIGS. 1-A, 1-B), the equatorial plane is referenced C, and a central rib that divides the tread in the circumferential direction is referenced 80.

FIG. 1-C is an illustration of the angle Beta that the mean plane of a longitudinal sipe makes with the circumferential direction XX′.

In order to optimize the arrangement of the elements, i.e. the way they succeed one another over a complete circuit of the tyre so as to reduce the whining and beating noise, each tread pattern element is associated with an elementary, for example sinusoidal, signal. For one complete circuit of the tyre, the associated signal is periodic and results from the sum of the elementary signals.

With the aid of a digital tool, the initial arrangement is optimized with respect to the whining and beating noise by carrying out simulations on different possible arrangements. Using a Fourier transform on the signal associated with the arrangement, the spectrum of the signal is analysed in the frequency domain. The criteria for stopping the optimization process are linked to the amplitude of the whining and beating features, and to their spread along the frequency axis.

At the end of this iterative approach, for the tyre size being studied, 245/35 R20 XL 95V, the total number of elements of the tread is established at 80 over one complete circuit of the tyre, arranged in the sequence: MB MA MB MA MA MA MA MA MA MA MB MB MB MB MB MA MB MA MB MA MA MA MA MA MA MA MB MB MA MA MA MB MA MB MB MB MB MB MA MA MA MB MA MB MB MA MA MA MA MA MB MB MB MB MA MA MA MA MA MB MA MB MB MA MA MA MB MA MB MA MB MB MB MA MB MA MA MA MA MA MB MB MB.

The circumference of the tyre is equal to 2108 mm and the width of the tread is 195 mm. The tread pattern of the tread of the manufactured tyre comprises 2 tread pattern elements (MA, MB) which are distributed as 48 elements MA, and 36 elements MB.

The following table recaps the features of the tread pattern elements (MA, MB):

TABLE 1

| | Number | | | |
|---|---|---|---|---|
| | of | | | Volumetric |
| | elements | Pitch (mm) | Area void ratio | void ratio |
| Element MA | NA = 48 | 21.9 | 40.2 | 28.7 |
| Element MB | NB = 36 | 29.37 | 42.2 | 28.8 |

The volumetric void ratio for each element (MA, MB) corresponds to the ratio of the volume of voids to the volume of each element (MA, MB). The area void ratio associated with an element (MA, MB) is defined in an equivalent manner. By extrapolation, the overall volumetric void ratio TEV corresponds to the ratio of the void volume VE to the total volume VT of the tread, such that TEV=VE/VT. The overall volumetric void ratio TEV for the tread of a tyre of the invention is comprised between [20%; 40%], and preferably between [25%; 35%].

The inventors have defined the sipe density for the tread pattern elements as being the ratio between the sum of the projected lengths (Lpx) of the sipes of a tread pattern element (MA, MB) in a circumferential direction to the product of the pitch (PA, PB) of the tread pattern element and the width (W) of the tread, all multiplied by 1000, such that:

$$SDmean = \frac{SDA * NA * PA + SDB * NB * PB}{NA * PA + NB * PB} .$$

where (NA, NB) are the number of sipes in each tread pattern element (MA, MB), and Lpxi is the projected length of the ith sipe of the element concerned.

According to the inventors, in the definition of (SDA, SDB), the denominator corresponds to the area containing a tread pattern element (MA, MB) so that the sipe density represents the quantity of edge corners of a tread pattern element (MA, MB) over the encompassing surface area. The higher the density, the more sipes the tyre tread comprises and, therefore, the better its grip performance on wet and snow-covered surfaces.

The sipe density (SDA, SDB) of each tread pattern element (MA, MB) is at least equal to 10 mm⁻¹ and at most equal to 70 mm⁻¹.

From the sipe densities of the tread pattern elements, it is possible to deduce the mean sipe density:

$$SDA = \frac{{\sum }_{i = 1}^{NA} Lpxi}{PA * W} * 1000 , and SDB = \frac{{\sum }_{i = 1}^{NB} Lpxi}{PB * w} * 1000$$

By construction, the mean sipe density SDmean is at least equal to 10 mm⁻¹ and at most equal to 70 mm⁻¹.

FIG. 2 shows a simplified extract from a developed view of a tread 10 of the invention, where a succession of elements (MA, MB) with their pitch (PA, PB) may be seen. The tread 10 is directional, having a favoured direction of running referenced 25. A rib 80 passing through the equatorial plane of the tread divides the tread into a first side edge 24D and a second side edge 24G. A portion ZB at each of the ends of the tread extends over an axial width that represents approximately 25% of the total width W of the tread. The tread is in contact at each of its axial ends with a sidewall which extends radially inwards as far as a bead. FIG. 2 also shows the longitudinal sipes 50 which have a circumferential overall direction, and the number of which may vary from one element to another. The sipe 50 is a cut comprising walls (51, 52) defining a mean plane 53. Between the tread pattern elements (MA, MB) the bottom of the tread 40 may be seen. The elements extend radially outwards from the bottom 40 towards the tread surface over a radial height which corresponds to the height of the tread pattern which varies slightly, decreasing from the centre towards the axial ends of the tread.

The “edges” 24G, 24D of the tread 10 are understood to be the surfaces that delimit the boundaries between the tread 10 and the sidewalls 60. These two edges 24G, 24D are distant from one another by a value W corresponding to the width of the tread 10.

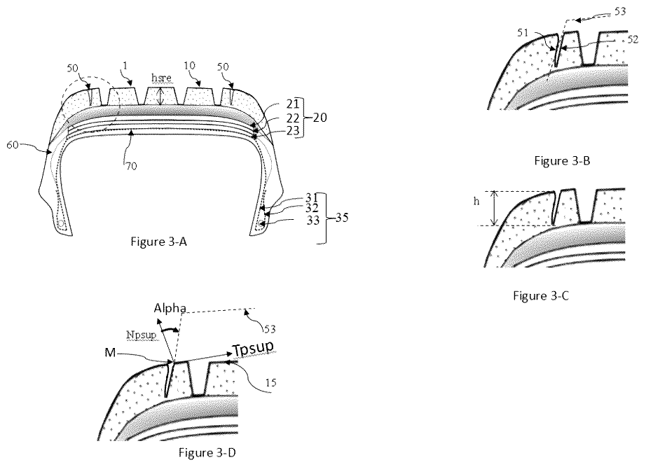

FIG. 3-A gives a view in a meridian plane of the tyre with general reference 1, better showing the height of the tread pattern of the tread 10 which is laid atop the crown 20 comprising the crown layers (21, 22, 23), first a hooping layer 21 radially on the inside of the tread, followed by two crossed layers (22, 23) representing the working layers which are radially on the inside of the hooping layer 21. The tyre 1 also comprises a carcass reinforcement 70 consisting of reinforcers coated in a rubber composition, and two beads 35 intended to be in contact with a rim. Said carcass reinforcement 70 connects the two beads 35 and comprises a main branch 31 which is wrapped around an annular reinforcing structure 33 to form a turnup 32. The sidewalls 60 connect the beads 35 to the tread 10.

FIGS. 3-B, 3-C, and 3-D are enlargements of the part circled in FIG. 3-A of the sipe 50 so as to show the walls (51, 52) of a sipe 50, and the mean plane 53 thereof. The depth h of a sipe is always less than the height of the tread pattern Hsre.

More particularly, the mean plane 53 of the sipe 50 may be seen in FIG. 3-D. The point M is at the intersection of said mean plane 53 and the tread surface 15, visualized here in a meridian plane. The external normal Npsup to the mean surface 15 makes an angle Alpha with said mean plane 53. The direction tangential to the point M at the tread surface 15 is denoted Tpsup.

As regards the material of the tread, its composition is collated in Table 2 below:

TABLE 2

| | Elastomer: | | | | | | |
|---|---|---|---|---|---|---|---|
| | SBR | Elastomer: | | | | | |
| | (Styrene | BR | | | | | |
| | Butadiene | (Butadiene | Reinforcing | | | | |
| | Rubber) | Rubber) | filler: silica | Antioxidant | Sulfur | Accelerator | Plasticizer |
| Tread | 60 | 40 | 115 | 4.5 | 1.4 | 1.6 | 72.3 |
| compound | | | | | | | |

The tread compound for the tyre of the invention and used in this example is based on a styrene butadiene rubber (elastomer). Plasticizers (reinforcing resin) are incorporated into the composition to facilitate the processability of the compounds. The compound also comprises vulcanization agents, sulfur, an accelerator, and protection agents.

The associated mechanical and viscoelastic properties, measured at 23° C. under a strain amplitude of 10%, are summarized in Table 3:

TABLE 3

| | G′ (MPa) | G″ (MPa) | Tan (δ) max |
|---|---|---|---|
| Tread compound | 1.82 | 0.64 | 0.367 |

The tyre of the invention was tested in order to highlight the performance offered by the invention. The results of these tests were compared with those obtained on a control tyre T.

The control T was a tyre of conventional design comprising a tread pattern without longitudinal sipes on the lateral portions. Said tread was made of a material suitable for winter use.

The test of transverse grip on snow-covered surfaces consists in timing each lap of the vehicle on a circular circuit covered with snow. The lower the lap time, the better the performance of the tyre.

The tests of longitudinal grip on a snow-covered surface, and on a wet surface, and the tyre noise were conducted in accordance with the stipulations of the regulation UNECE/R117.

The test of grip on a dry surface consists in conducting a braking test with a vehicle equipped with an ABS system. The shorter the stopping distance, the better the performance of the tyre.

A result greater than (respectively less than) 100% indicates an improvement (respectively a diminution) in the performance aspect under consideration.

The results obtained are summarized in Table 4 below:

TABLE 4

| | | Longitudinal | | | |
|---|---|---|---|---|---|
| | | grip - Snow | | | |
| | | In | Longitudinal | | Tyre noise |
| | | accordance | grip - wet surface | Longitudinal | In accordance |
| | Transverse | with | In accordance | grip - dry | with |
| | grip - Snow | UNECE/R117 | with UNECE/R117 | surface | UNECE/R117 |
| T | 100 | 100 | 100 | 100 | 100 |
| P | 103 | 99 | 102 | 100 | 100 |

The tyre of the invention achieves the desired compromise between grip on snow-covered surfaces without significant impairment of grip on dry surfaces. The tyre noise is under control, remaining at a level consistent with the type-testing certification thresholds of regulation R117, and the grip on wet surfaces benefits from the longitudinal sipes, being at a higher level than in the control T.

1.-15. (canceled)

16. A tire comprising a tread (10) which is intended to come into contact with a ground via a tread surface (15):
the tread (10) comprising raised elements that are organized into at least two tread pattern elements MA, MB which are separated from one another at least in part by cuts (30) and extend radially toward an outside from a bottom surface (40) as far as the tread surface (15) over a maximum radial height Hsre at least equal to 6 mm;
a path of a cut along the tread surface (15) defining a mean geometric profile which is situated at a mean distance from edge corners formed by walls of the cut;
in a meridian section of the tire, a point M being defined at an intersection of the mean geometric profile (53) and of the tread surface (15), and at point M, Npsup being an external normal to the tread surface (15);
a pitch PA or PB being respectively associated with the tread pattern element MA or MB, the pitch of a tread pattern element being a distance, measured on a circumference of the tire, between a point on the tread pattern element and a translated image of the point on an immediately next tread pattern element in a direction of running;
a complete tread being obtained by repeating the tread pattern elements MA, MB at the pitches PA, PB over a complete circuit of the tire with PA<PB;
each tread pattern element MA, MB comprising a first lateral portion ZB extending from one axial end of an edge of the tread (24G, 24D) over an axial width at most equal to 25% of an axial width W of the tread; and
a longitudinal sipe being a cut in at least a lateral portion ZB of a tread pattern element MA, MB in which a distance between walls of material that delimit the longitudinal sipe is less than or equal to 2 mm and a depth of which is greater than or equal to 1 mm,
wherein each first lateral portion ZB contains at least one longitudinal sipe (50) of which a path on the tread surface is a mean plane (53) that makes an angle Beta with a circumferential direction XX′, which angle, in terms of absolute value, is comprised within a range [0°, 20°],
wherein the mean plane (53) of the at least one longitudinal sipe (50) makes an angle Alpha with the external normal Npsup, which angle is comprised within a range [3°; 55°], the angle Alpha being oriented from the external normal Npsup toward the mean plane (53), and
wherein a sum of projected lengths of the at least one longitudinal sipe (50) in the circumferential direction XX′ onto all of the first lateral portions ZB is comprised between 0.5 times and 5 times the circumference of the tire measured in an equatorial plane.

17. The tire according to claim 16, wherein the angle Alpha is comprised within the range [5°; 55°].

18. The tire according to claim 16, wherein the angle Beta is comprised within the range [5°; 15°].

19. The tire according to claim 16, wherein each first lateral portion ZB contains at least two longitudinal sipes (50).

20. The tire according to claim 19, wherein the angles Beta of the longitudinal sipes (50) vary such that the angles Beta increase from the edges (24G, 24D) toward a center C of the tread (10).

21. The tire according to claim 19, wherein an axial distance between two consecutive longitudinal sipes (50) of a lateral portion ZB is comprised between [3; 17] mm, the axial distance between two consecutive longitudinal sipes (50) being a distance between two closest ends.

22. The tire according to claim 19, a contact patch being defined by points of the tire that are in contact with the ground when the tire is compressed by a load at a nominal pressure, the load and pressure being as specified according to ETRTO, wherein, for at least one tread pattern element MA or MB, the longitudinal sipe (50) of a lateral portion ZB which is axially outermost and in contact with the ground is situated at most 10 mm away from a first circumferential edge of the contact patch.

23. The tire according to claim 22, wherein, for at least one tread pattern element MA or MB, the longitudinal sipe (50) of a lateral portion ZB which is axially innermost and in contact with the ground is situated at most 60 mm away from a first circumferential edge of the contact patch.

24. The tire according to claim 16, wherein a depth h of a longitudinal sipe (50) of a lateral portion ZB is between 20% and 80% of the maximum radial height of the tread pattern Hsre.

25. The tire according to claim 16, a width of a longitudinal sipe being an axial distance between two walls of the longitudinal sipe, wherein the width of a longitudinal sipe (50) of a lateral portion ZB is comprised between 0.3 mm and 2 mm.

26. The tire according to claim 16, an overall volumetric void ratio TEV corresponding to a ratio of a void volume VE to a total volume VT of the tread, such that TEV=VE/VT, wherein the overall volumetric void ratio TEV of the tread is comprised between [20%, 40%].

27. The tire according to claim 16, the tread forming a contact patch AC in which the tire is in contact with the ground when the tire is running, and part of the tread pattern elements also forming a contact surface SC in the contact patch AC thereby determining an area void ratio TES of the tread, where
$$TES = \frac{{A}_{C} - {S}_{C}}{{A}_{C}} ,$$
wherein TES is comprised within the range [0.35; 0.6].

28. The tire according to claim 16, wherein a ratio between the pitch PA of the first tread pattern element MA divided by the pitch PB of the second tread pattern element MB, PA/PB, is at least equal to 0.60 and at most equal to 0.90.

29. The tire according to claim 16, the tread comprising at least a third tread pattern element MC with an associated pitch PC, where PB is smaller than PC, wherein a ratio of the pitches PB/PC is greater than or equal to a ratio of the pitches PA/PB.

30. The tire according to claim 16, wherein a composition of a rubbery material of the tread has a glass transition temperature Tg comprised between −40° C. and −10° C. and a complex dynamic shear modulus G* measured at 60° C. comprised between 0.5 MPa and 2 MPa.
